(19) United States
(12) Patent Application Publication
(10) Pub. No.: US 2005/0264223 A1
(43) Pub. Date: Dec. 1, 2005

(54) Method of driving electron emission device with decreased signal delay

(76) Inventors: Ji-Won Lee, Suwon-si (KR); Chul-Ho Lee, Suwon-si (KR)

Correspondence Address: Robert E. Bushnell, Suite 300, 1522 K Street, N.W., Washington, DC, 20005, US

(21) Appl. No.: 11/139,676

(22) Filed: May 31, 2005

(30) Foreign Application Priority Data
May 31, 2004 (KR) 10-2004-0039250

(51) Int. Cl. H05B 37/00

(52) U.S. Cl. 315/160

(57) ABSTRACT

A method of driving an EED device can prevent the luminance from being degraded due to the delay of the display data signals applied to the electrode lines. In an EED device in which display data signals having pulse widths according to gray scales are applied to data electrode lines while scan signals are applied to the scan electrode lines intersected with the data electrode lines, the method of driving the EED device is characterized in that the display data signals. applied to the data electrode lines include odd data signals and even data signals, which respectively correspond to an odd scan signal and an even scan signal, and pulses of the odd and even data signals maintain pulse widths according to respective gray scales and are continuous with blanking periods interposed therebetween.

### CLAIM OF PRIORITY

This application makes reference to, incorporates the same herein, and claims all benefits accruing under 35 U.S.C. §119 from an application for DRIVING METHOD OF ELECTRON EMISSION DEVICE WITH DECREASED SIGNAL DELAY earlier filed in the Korean Intellectual Property Office on 31 May 2004 and there duly assigned Serial No. 10-2004-0039250.

### BACKGROUND OF THE INVENTION

1. Field of the Invention

The present invention relates to a method of driving an electron emission display device with a decreased signal delay, and more particularly, to a method of driving an electron emission display device with a decreased signal delay, in which a rising time of signal is decreased by successively arranging an odd display data signal and an even display data signal.

2. Description of the Related Art

Electron emission display (EED) device includes an EED panel and a driver part. In such a state that the driver part applies a positive voltage to an anode electrode of the EED panel, if a positive voltage is applied to a gate electrode and a negative voltage is applied to a cathode electrode, electrons are emitted from the cathode electrode. The emitted electrons are accelerated toward the gate electrode and converged into the anode electrode. Then, the electrons collide against fluorescent cells disposed in front of the anode electrode, thereby emitting light.

The gate electrodes and the cathode electrodes can be respectively used as scan electrodes and data electrodes, and vice versa.

Gray level control methods for adjusting luminance of the EED panel include a pulse width modulation (PWM) scheme which controls an applying time of data signal pulse and a pulse amplitude modulation (PAM) scheme which controls a voltage amplitude of data signal pulse. According to the PWM scheme, a panel controller generates gray scale signals depending on gray scale information included in the video data. A data driver modulates the pulse width of the data driving signal included in the data driving control signal, depending on the gray scale signals. Then, The PWM-ed signal is boosted to a voltage at which the panel electrodes can be driven, such that the resultant display data signal is generated to the data electrode lines. According to the PAM scheme, the data driver modulates the pulse amplitude of the data driving signal included in the data driving control signal, depending on the gray scale signals. Then, the PAM-ed signal is boosted to a voltage at which the panel electrodes can be driven, such that the resultant display data signal is generated to the data electrode lines.

FIGS. 1A and 1B are waveforms of signals applied to data electrode lines and scan electrode lines according to a conventional PWM scheme.

Referring to FIG. 1A, when negative scan signals having predetermined width are repeatedly applied to scan electrode lines in sequence, display data signals having different pulse widths PW according to a luminance are applied to one data electrode line. For example, when first and second data signals Data[n] and Data[n+1] have the same gray scale, their output pulse widths are also equal to each other (PW[n]=PW[n+1]). When a third data signal Data[n+2] has a low gray scale, its output pulse width PW[n+2] is narrow, and when a fourth data signal Data[n+3] has a high gray scale, its output pulse width PW[n+3] is wide.

FIG. 1B illustrates a case when polarities of the scan signal and the display data signal are inverted. In this case, an operation of FIG. 1B is equal to that of FIG. 1A.

Generally, the waveform shown in FIG. 1A is used when the scan electrode lines and the data electrode lines are respectively the cathode electrode and the gate electrode, and the waveform shown in FIG. 1B is used when the scan electrode lines and the data electrode lines are respectively the gate electrode and the cathode electrode. However, it is not limited to them.

FIG. 2 is an ideal pulse waveform of the display data signal applied to the EED panel, and FIG. 3 is a pulse waveform of a signal distorted or delayed due to impedance components of the electrode lines in the EED panel.

When the display data signal is applied to the gate electrode lines, the positive display data signal is applied as shown in FIG. 2. Referring to FIG. 2, a display data signal having a voltage V_{data} exceeding an emission start voltage Vₜₕ is applied at a time point t1 and is ended at a time point t2. Accordingly, electrons must be emitted from the data electrodes at the time point t1.

However, the EED panel has impedance components, such as resistance and capacitance of the electrode lines, depending on environment factors or materials in the manufacturing processes. Thus, pulse waveforms of the display data signals or the scan signals applied to the EED panel may be distorted or delayed. Due to the pulse delay, the luminance of pixels receiving the display data signals may be degraded.

Referring to FIG. 3, due to the delay of the display data signal, the emission start time point is delayed from t1 to t1′, and the emission end time point is delayed from t2 to t2′. Also, the ideal pulse width PW of FIG. 2 is actually outputted like the reduced pulse width PW′ of FIG. 3. In this case, since an energy represented by an area “A1” is not outputted from the EED panel, the light luminance may be degraded. When the scan signal continues to be outputted after the time point t2, an unintended energy represented by an area “A2” is outputted. In this case, since the energy A1 is larger than the unintended energy A2, the luminance of light emitted from the EED panel is degraded. Accordingly, actual pulse widths are narrower than PW[n], PW[n+1], PW[n+2], PW[n+3], etc.

A technology for solving the delay and distortion of the display data signal is disclosed in Japanese Patent Laid-Open Publication No. 1995/181916 for Driving Circuit of Display Device by Mitsuru Tanaka. In this patent, a voltage selector is installed within a data driver. The voltage selector additionally modulates a pulse amplitude of a PWM-ed data signal, such that an luminance information is added to the PWM-ed data. Thus, the luminance of the panel is increased and the signal delay is reduced. However, when the modulation level of the PAM is large, a fine voltage modulation is still difficult.

In Korean Patent Laid-Open Publication No. 1998/0082973 for LCD Driving Method and Apparatus by Yoon-Chul Chung, a negative (−) tab voltage is applied at a falling edge of a scan voltage, such that a falling width of a scanning voltage becomes large. As a result, a delay time is reduced. However, due to the variation in the amplitude of the voltage, the luminance may be changed different1y unlike the purpose of the developer.

Also, U.S. Patent Laid-Open Publication No. 2004/0004588 for Driving Method and Driving Apparatus for a Field Emission Device by Kawase et al. discloses a compensation circuit. In this patent, considering that an emission current is reduced as a time elapses, a gate electrode is driven with a voltage higher than a drive voltage of a reference level, and an FET is coupled to a cathode electrode so that a current cannot flow more than a desired current. However, since the luminance according to the gray level outputted from a panel is nonlinear with respect to an emission current and a drive voltage, it is impossible to adaptively compensate for a correct drive voltage for outputting a desired luminance. Also, when an excessive drive voltage is applied to a data electrode, an electron emission source may be easily degraded and the lifespan of the device may be shortened.

### SUMMARY OF THE INVENTION

It is therefore an object of the present invention to provide a method of driving an EED. device, capable of decreasing waveform distortion and signal delay of display data signals, which are caused by an impedance of data electrode lines.

It is another object of the present invention to provide a technique of driving an EED device that can prevent the degradation of the luminance which is caused by the waveform distortion and the signal delay due to the impedance of the panel electrode lines, thereby increasing the luminance and the energy efficiency.

It is yet another object of the present invention to provide a technique for driving an EED that can prevent the non-uniformity of the luminance between the pixels to which the same data are applied, where, the waveform distortion according to the impedance of the data electrode lines are greatly reduced, thereby reducing the non-uniformity of the luminance between the up and down, right and left pixels to which the same data are applied.

It is another object of the present invention to provide a driving method and apparatus for an EED that is efficient, easy to implement and reliable.

According to an aspect of the present invention, there is provided a method of driving an EED (electron emission display) device, in which display data signals having pulse widths according to gray scales are applied to data electrode lines while scan signals are applied to the scan electrode lines of an EED panel, the data electrode lines being intersected with the scan electrode lines. The method is characterized in that the display data signals applied to the data electrode lines include odd data signals and even data signals, which respectively correspond to an odd scan signal and an even scan signal, and pulses of the odd and even data signals maintain pulse widths according to respective gray scales and are continuous with blanking periods interposed therebetween. Since the rising time necessary for signal rising of an output pulse of the display data signal is not required, the signal delay and the waveform distortion do not occur, thereby preventing the degradation of luminance.

The pulses of the odd data signals are delayed and maintained up to the blanking periods so as to maintain pulses widths according to the gray scales. Also, the pulses of the even data signals are maintained from the blanking periods to the pulse widths according to the gray scales.

If the data signals have gray scales lower than a predetermined gray scale, pulses of the odd and even data signals maintain pulse widths according to respective gray scales and are continuous with blanking periods interposed therebetween, and if the data signals have gray scales higher than the predetermined gray scale, pulses of the odd data signals exceed an emission start voltage at the same time when data signals are applied, such that the pulse widths according to the gray scales are maintained. That is, the data signals may be applied so as not to be maintained until the blanking periods. When the gray scale is so high that it is not influenced by the signal delay, the pulses of the odd data signals are not delayed until the blanking periods. When the gray scale is so low that it is influenced by the signal delay, the pulses of the odd data signals are delayed until the blanking periods.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1A and 1B are waveforms of signals applied to data electrode lines and scan electrode lines according to a conventional PWM scheme;

FIG. 2 is an ideal pulse waveform of the display data signal applied to an EED panel;

FIG. 3 is a pulse waveform of a signal distorted or delayed due to impedance components of electrode lines in an EED panel;

FIG. 4 is a schematic block diagram of an EED device according to an embodiment of the present invention;

FIG. 5 is a perspective view of an EED panel in an EED device according to an embodiment of the present invention;

FIGS. 6A and 6B are waveforms illustrating a method of driving an EED device according to an embodiment of the present invention; and

FIG. 7 is a conceptual diagram illustrating voltages of display data signals applied to data electrode lines as scan signals are sequentially applied to scan electrode lines.

### DETAILED DESCRIPTION OF THE INVENTION

The present invention will now be described more fully with reference to the accompanying drawings, in which exemplary embodiments of the invention are shown.

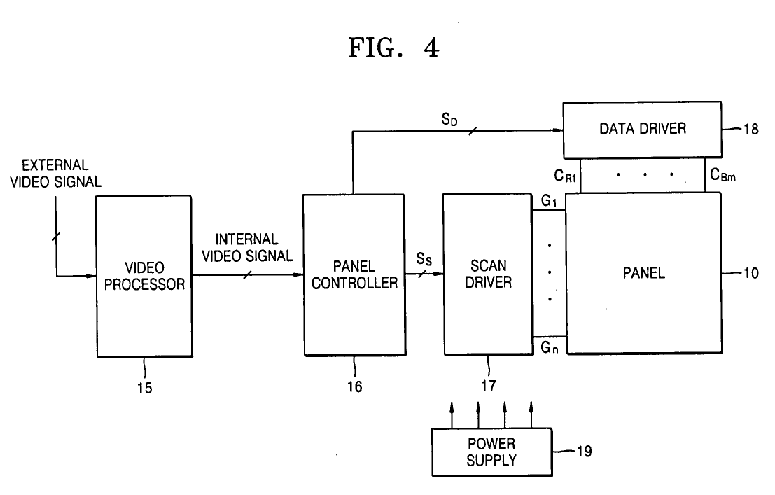

FIG. 4 is a schematic block diagram of an EED device to which a driving method according to an embodiment of the present invention can be applied.

Referring to FIG. 4, an EED device includes an EED panel 10 and a driver part. The driver part includes a video processor 15, a panel controller 16, a scan driver 17, a data driver 18, and a power supply unit 19.

The video processor 15 converts an external analog video signal into a digital signal to generate an internal video signal, for example, R (red), G (green) and B (blue) video data, a clock signal, horizontal and vertical synchronization signals.

The panel controller 16 generates data driving control signals S_{D} and scan driving control signal S_{S} according to the internal video signal outputted from the video processor 15. The data driver 18 processes the data driving control signal S_{D} and generates a display data signal to data electrode lines of the EED panel 10. The data electrode lines may use cathode electrode lines C_{R1} to C_{Bm} or gate electrode lines G₁ to Gₙ. The scan driver 17 processes the scan driving control signal S_{S} and applies the processed signal to scan electrode lines. The scan electrode lines may use the gate electrode lines G₁ to Gₙ or the cathode electrode lines C_{R1} to C_{Bm}.

The power supply unit 19 supplies a power to the video processor 15, the panel controller 16, the scan driver 17, the data driver 18, and an anode electrode of the EED panel 10.

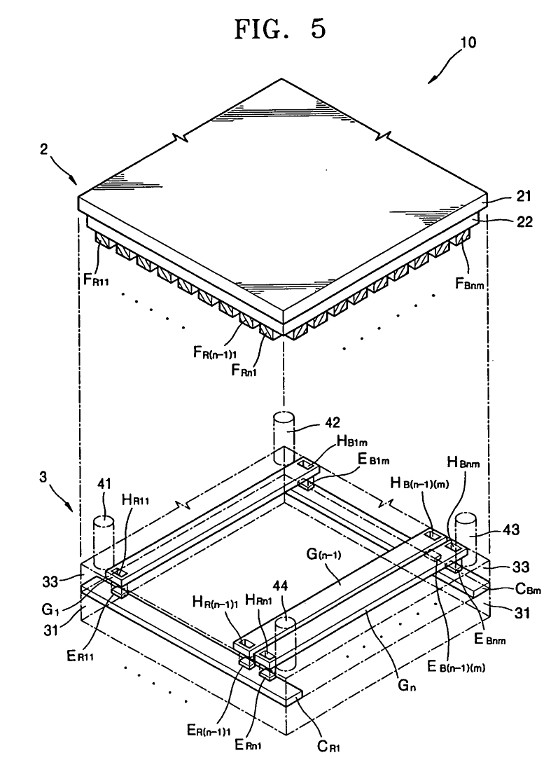

FIG. 5 is a perspective view of an EED panel in an EED device according to an embodiment of the present invention.

Referring to FIG. 5, an EED (electron emission display) panel 10 includes a front panel 2 and a rear panel 3, which are supported space bars 41 to 43.

The rear panel 3 includes a rear substrate 31, cathode electrode lines C_{R1} to C_{Bm}, electron emitting sources E_{R11} to E_{Bnm}, an insulating layer 33, and gate electrode lines G₁ to Gₙ.

Display data signals are applied to the cathode electrode lines C_{R1} to C_{Bm}. The cathode electrode lines C_{R1} to C_{Bm} are electrically connected to the electron emitting sources E_{R11} to E_{Bnm}. Through-holes H_{R11} to H_{Bnm} corresponding to the electron emitting sources E_{R11} to E_{Bnm} are formed at a first insulating layer 33 and the gate electrode lines G₁ to Gₙ. Accordingly, the through-holes H_{R11} to H_{Bnm} are formed at areas where the cathode electrode lines C_{R1} to C_{Bm} intersects with the gate electrode lines G₁ to Gₙ to which scan signals are applied.

The front panel 2 includes a front transparent substrate 21, an anode electrode 22, and fluorescent cells F_{R11} to F_{Bnm}. High positive electric potential of 1-4 KV (kilovolts) are applied to the anode electrode 22, allowing the electrons to move from the electron emitting sources E_{R11} to E_{Bnm}, to the fluorescent cells.

An operation of the EED device will now be described.

It is assumed that the data electrode lines are connected to the cathode electrodes C_{R1} to C_{Bm} of the EED panel 10 and the scan electrode lines are connected to gate electrodes G₁ to Gₙ. In such a state that a positive voltage is applied to the anode electrode, if a positive voltage is applied to the gate electrodes G₁ to Gₙ through the scan electrode lines and a negative voltage is applied to the cathode electrodes C_{R1} to C_{Bm} through the data electrode lines, electrons are emitted from the cathode electrodes. The emitted electrons are accelerated toward the gate electrodes and converged into the anode electrodes. Then, the electrons collide against fluorescent cells disposed in front of the anode electrodes, thereby emitting light.

It is apparent that the present invention can also be applied when the data electrode lines and the scan electrode lines are respectively connected to the gate electrodes G₁ to Gₙ and the cathode electrodes C_{R1} to C_{Bm}.

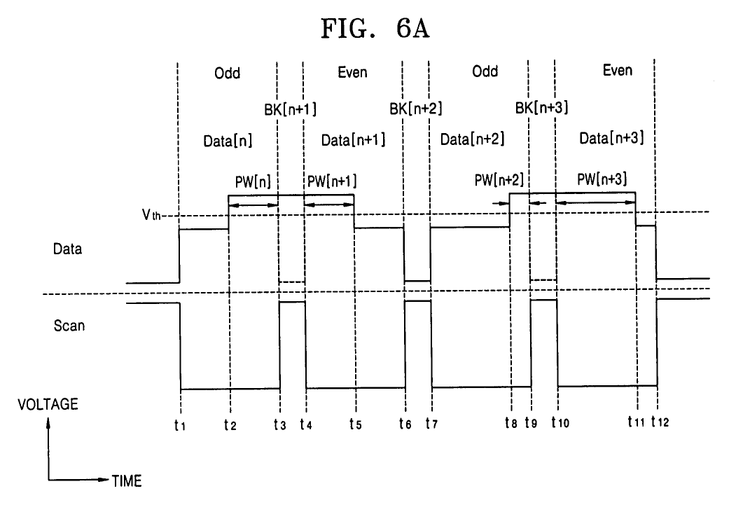

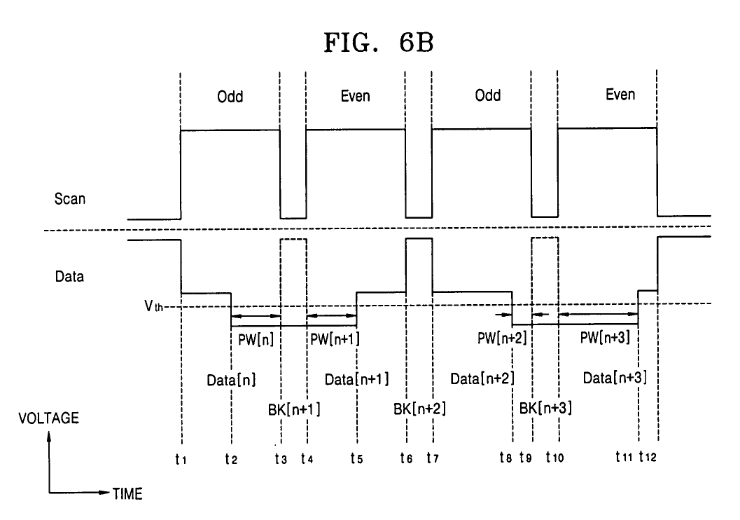

FIGS. 6A and 6B are waveforms illustrating voltages of the display data signals applied to the data electrode lines with respect to time while the scan signals are sequentially applied to the scan electrode lines. In FIG. 6A, a lower portion of the signal waveform represents negative scan signals sequentially applied to the scan electrode lines which are connected to the panel, and an upper portion of the signal waveform represents positive display data signals applied to one data electrode line. In FIG. 6B, an upper portion represents positive scan signals, and a lower portion represents negative display data signals.

Generally, the waveform shown in FIG. 6A is used when the scan electrode lines and the data electrode lines are respectively the cathode electrode and the gate electrode, and the waveform shown in FIG. 6B is used when the scan electrode lines and the data electrode lines are respectively the gate electrode and the cathode electrode. However, it is not limited to them.

First, data driving signals outputted from the panel controller 16 are converted into display data signals having predetermined voltage levels by the data driver. The data driving signals are control driving signals for the display data signals applied to the electrode lines of the panel 10. For example, the data driving signals are converted into the display data signals by performing the PWM (pulse width modulation) process in proportion to gray scale information within the data driver 18 and boosting into high voltages having levels necessary for driving the electrode lines.

As can be seen from the display data signals shown in the upper portion of FIG. 6A, the display data signals applied to one data electrode line include pairs of an odd data signal and an even data signal.

For example, while the scan signals shown in the lower portion of FIG. 6A are applied to the scan electrode lines of the EED panel, the display data signals having pulse widths according to the gray scales are applied to the data electrode lines, as shown in the upper portion of FIG. 6A.

The waveforms of the display data signals include active periods Data[n], Data[n+1], Data[n+2], Data[n+3], etc. (where, n is a positive integer) at which the respective data signals are applied, and blanking periods BK[n+1], BK[n+2], BK[n+3], etc. (where, n is a positive integer) existing between the respective data signals.

Considering the omitted waveforms, pulses of odd data signals Data[n], Data[n+2], Data[n+4], Data[n+6], etc. (where, n is a positive integer) and pulses of even data signals Data[n+1], Data[n+3], Data[n+5], Data[n+7], etc. (where, n is a positive integer) maintain pulse widths according to the respective gray scales, and are continued by inserting the blanking periods BK[n+1], BK[n+2], BK[n+3], BK[n+4], etc. (where, n is a positive integer) interposed therebetween. For example, in FIG. 6A, the first odd data signal Data[n] and the first even data signal Data[n+1] are continued centering on the blanking period BK[n+1] interposed therebetween. In case of the first odd data signal Data[n], the pulse exceeding the emission start voltage Vₜₕ is started not at the time point t1 when the data signal is applied, but at the delayed time point t2 when the pulse width PW[n] according to the gray scale is maintained. Also, the pulse width PW[n] is maintained so that the end time point of the pulse width PW[n] necessary for the gray scale expression can be equal to the start time point t3 of the blanking period BK[n+1]. At this time, the data driver must correctly calculate the pulse start time point t2 so that the pulse width PW[n] necessary for the gray scale expression can be maintained.

In FIG. 6A, the first odd data signal Data[n] and the even data signal Data[n+1] applied to the data line have the same gray scale, so that their pulse widths PW[n] and PW[n+1] are equal to each other. The waveforms representing the pulse widths PW[n] and PW[n+1] are continuous and symmetrical centering on the blanking period BK[n+1] interposed therebetween. The third data signal Data[n+2] applied to the data line has a gray scale lower than the fourth data signal Data[n+3], so that the pulse width PW[n+2] of the third data signal is narrower than the pulse width PW[n+3] of the fourth data signal. The pulses of the odd data signals Data[n], Data[n+2], etc., are delayed and maintained until the start time points t3, t9, etc., of the blanking periods BK[n+1], BK[n+2], etc., so as to maintain the pulse widths according to the gray scales. Also, the pulses of the even data signals Data[n+1], Data[n+3], etc., are maintained from the end time points t4, t10, etc., of the blanking periods BK[n+1], BK[n=2], etc., until the pulse widths according to the gray scales.

As described above, if the pulses of the odd data signals and the even data signals are applied continuously, including the blanking periods, to the data electrode lines while maintaining the pulse widths according to the respective gray scales, the rising time necessary for the signal rising of the output pulse of the display data signal is not required. Thus, the signal delay and waveform distortion do not occur, thereby preventing the luminance from being degraded. Specifically, the pulses PW[n+1], PW[n+3], etc., exceed the emission start voltage Vₜₕ without any rising time at the start time points t4, t10, etc., and thus the signal delay does not occur.

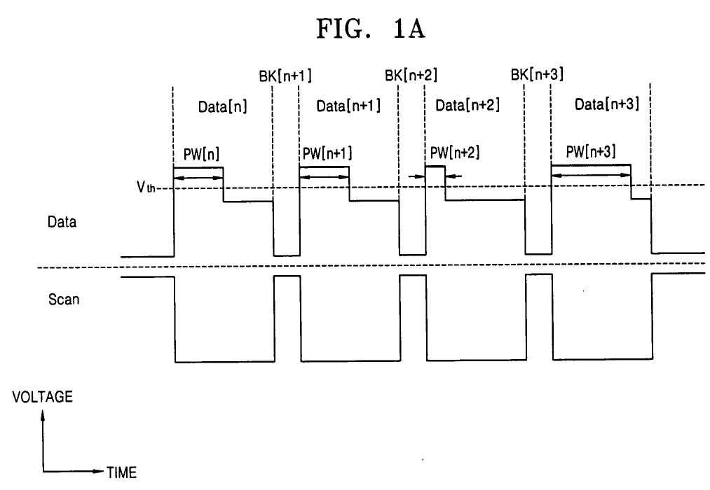

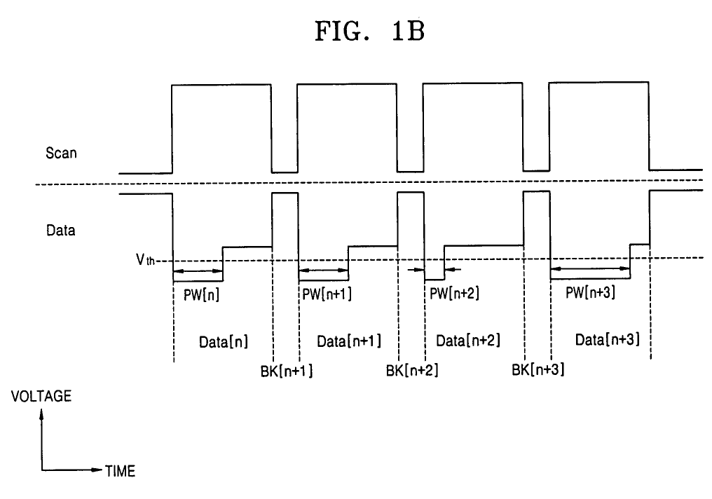

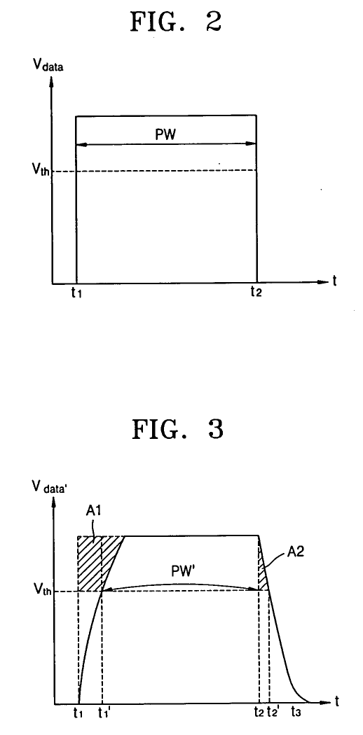

The waveforms of FIGS. 6A and 6B are in an up-and-down (vertical) symmetry. Generally, the waveform shown in FIG. 6B is used when the scan electrode lines and the data electrode lines are respectively the cathode electrode and the gate electrode, and the waveform shown in FIG. 1B is used when the scan electrode lines and the data electrode lines are respectively the gate electrode and the cathode electrode. However, it is not limited to them. In some cases, the signals shown in FIG. 6A can be used, depending on the design specification of the panel electrode lines.

As can be seen in the lower portion of FIG. 6B, the display data signals applied to one data electrode line are paired with the odd data signals and the even data signals.

For example, while the scan signals shown in the upper portion of FIG. 6B are applied to the scan electrode lines, the display data signals having the pulse widths according to the gray scales are applied to the data electrode lines, as shown in the lower portion of FIG. 6B.

The waveforms of the display data signals include active periods Data[n], Data[n+1], Data[n+2], Data[n+3], etc., (where, n is a positive integer) at which the respective data signals are applied, and blanking periods BK[n+1], BK[n+2], BK[n+3], etc., (where, n is a positive integer) existing between the respective data signals.

Considering the omitted waveforms, pulses of odd data signals Data[n], Data[n+2], Data[n+4], Data[n+6], etc., (where, n is a positive integer) and pulses of even data signals Data[n+1], Data[n+3], Data[n+5], Data[n+7], etc., (where, n is a positive integer) maintain pulse widths according to the respective gray scales, and are continued by inserting the blanking periods BK[n+1], BK[n+2], BK[n+3], BK[n+4], etc., (where, n is a positive integer) interposed therebetween. For example, in FIG. 6B, the first odd data signal Data[n] and the first even data signal Data[n+1] are continued centering on the blanking period BK[n+1] interposed therebetween. In case of the first odd data signal Data[n], the pulse exceeding the emission start voltage Vₜₕ is started not at the time point t1 when the data signal is applied, but at the delayed time point t2 when the pulse width PW[n] according to the gray scale is maintained. Also, the pulse width PW[n] is maintained so that the end time point of the pulse width PW[n] necessary for the gray scale expression can be equal to the start time point t3 of the blanking period BK[n+1]. At this time, the data driver must correctly calculate the pulse start time point t2 so that the pulse width PW[n] necessary for the gray scale expression can be maintained.

In FIG. 6B, the first odd data signal Data[n] and the even data signal Data[n+1] applied to the data line have the same gray scale. The waveforms representing the pulse widths PW[n] and PW[n+1] are continuous and symmetrical centering on the blanking period BK[n+1] interposed therebetween.

The third data signal Data[n+2] applied to the data line has a gray scale lower than the fourth data signal Data[n+3], so that the pulse width PW[n+2] of the third data signal is narrower than the pulse width PW[n+3] of the fourth data signal. The pulses of the odd data signals Data[n], Data[n+2], etc., are delayed and maintained until the start time points t3, t9, etc., of the blanking periods BK[n+1], BK[n+2], etc., so as to maintain the pulse widths according to the gray scales.

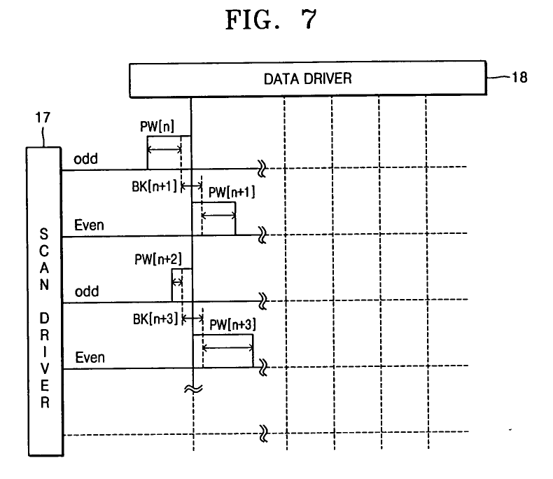

FIG. 7 is a conceptual diagram illustrating the voltages of the display data signals applied to the data electrode lines as the scan signals are sequentially applied to the scan electrode lines.

For convenience's sake, one of the data electrode lines connected to the panel is illustrated in FIG. 7. The waveform of the display data signal applied to one data electrode line is paired with the odd data signals and the even data signals and is continuous.

For example, in FIG. 7, the first odd data signal Data[n] and the first even data signal Data[n+1] are continuous centering on the blanking period BK[n+1] interposed therebetween.

The first odd data signal Data[n] and the first even data signal Data[n+1] have the same gray scale, and thus their pulse widths PW[n] and PW[n+1] are equal to each other. The waveforms representing the pulse widths PW[n] and PW[n+1] are continuous and symmetrical centering on the blanking period BK[n+1] interposed therebetween. The third data signal Data[n+2] applied to the data line has a gray scale lower than the fourth data signal Data[n+3], so that the pulse width PW[n+2] of the third data signal is narrower than the pulse width PW[n+3] of the fourth data signal. The pulses of the odd data signals Data[n], Data[n+2], etc., are delayed and maintained until the start time points of the blanking periods BK[n+1], BK[n+2], etc., so as to maintain the pulse widths according to the gray scales. Also, the pulses of the even data signals Data[n], Data[n+2], etc., are maintained from the end time points of the blanking periods BK[n+1], BK[n+2], etc., to the pulse widths according to the gray scales.

As described above, if the pulses of the odd data signals and the even data signals are applied continuously, including the blanking periods, to the data electrode lines while maintaining the pulse widths according to the respective gray scales, the rising time necessary for the signal rising of the output pulse of the display data signal is not required. Thus, the signal delay and waveform distortion do not occur, thereby preventing the luminance from being degraded. Specifically, the pulses PW[n+1], PW[n+3], etc., of the even data signals exceed the emission start voltage Vₜₕ without any rising time at the start time points t4, t10, etc., and thus the signal delay does not occur.

In order to apply the data signal so that the pulse of the odd data signal and the pulse of the even data signal can be continued centering on the blanking period, the waveforms of the odd data signals Data[n], Data[n+2], Data[n+4], etc., must be modified, such that the operation time is required. Accordingly, when the gray scale to be displayed is so low that it is influenced by the signal delay, the data signal is applied such that the pulse of the odd data signal and the pulse of the even data signal can be continuous centering on the blanking period. Meanwhile, when the gray scale to be displayed is so high that it is not influenced by the signal delay, the data signal is applied with the typical waveforms.

For example, it is assumed that the gray scale at which the user feels inconvenient due to the signal delay is 2⁵/256. When the data signals have the gray scales less than 2⁵/256, the pulses of the odd data signals and the even data signals are applied continuously, including the blanking periods interposed therebetween, to the data electrode lines while maintaining the pulse widths according to the respective gray scales. When the data signals have the gray scales greater than 2⁵/256, the pulses of the odd data signals exceed the emission start voltage at the same time when the data signal is applied, such that the pulse widths according to the gray scales are maintained. Thus, the data signals can be applied to the electrode lines so as not to be maintained until the blanking period. That is, when the gray scale is so high that it is not influenced by the signal delay, the pulses of the odd data signals are not delayed until the blanking periods. When the gray scale is so low that it is influenced by the signal delay, the pulses of the odd data signals are delayed until the blanking periods, so that the operation burden on the driver part is reduced.

The present invention can prevent the degradation of the luminance which is caused by the waveform distortion and the signal delay due to the impedance of the panel electrode lines, thereby increasing the luminance and the energy efficiency.

Also, the present invention can prevent the non-uniformity of the luminance between the pixels to which the same data are applied. That is, the waveform distortion according to the impedance of the data electrode lines are greatly reduced, thereby reducing the non-uniformity of the luminance between the up and down (vertical), right and left (horizontal) pixels to which the same data are applied.

Specifically, since the even data signals can exceed the emission start voltage Vth without any rising time at the pulse start time point with respect to the pixels on the even scan electrode lines, the signal delay does not occur.

The present invention can also be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of driving an electron emission display device, the method comprising:
applying display data signals having pulse widths according to gray scales to data electrode lines while scan signals are applied to scan electrode lines of said electron emission display panel, said data electrode lines being intersected with said scan electrode lines;
generating the display data signals applied to said data electrode lines comprising odd data signals and even data signals, which respectively correspond to an odd scan signal and an even scan signal; and
maintaining pulse widths of pulses of the odd and even data signals according to respective gray scales and are continuous with blanking periods interposed therebetween.

2. The method of claim 1, wherein the pulses of the odd data signals are delayed and maintained up to the blanking periods so as to maintain pulse widths according to the gray scales.

3. The method of claim 1, wherein the pulses of the even data signals are maintained from the blanking periods to the pulse widths according to the gray scales.

4. The method of claim 1, wherein when the data signals have gray scales lower than a predetermined gray scale, pulses of the odd and even data signals maintain pulse widths according to respective gray scales and are continuous with blanking periods interposed therebetween, and when the data signals have gray scales higher than the predetermined gray scale, pulses of the odd data signals exceed an emission start voltage at the same time when data signals are applied, accommodating the pulse widths according to the gray scales being maintained, and are not continuous with pulses of even data signals in the blanking periods.

5. A driving apparatus for said electron emission display device according to the method of claim 1.

6. The method of claim 1, wherein when the data signals have gray scales lower than a predetermined gray scale, pulses of the odd and even data signals maintain pulse widths according to respective gray scales and are continuous with blanking periods interposed therebetween.

7. The method of claim 1, wherein and when the data signals have gray scales higher than the predetermined gray scale, pulses of the odd data signals exceed an emission start voltage. at the same time when data signals are applied, accommodating the pulse widths according to the gray scales being maintained, and are not continuous with pulses of even data signals in the blanking periods.

8. The method of claim 1, with a third data signal of the data signals applied to the data line has a gray scale lower than a fourth data signal, accommodating the pulse width of the third data signal being narrower than the pulse width of the fourth data signal.

9. The method of claim 1, with the pulses of the odd data signals being delayed and maintained until the start time points of the blanking periods, accommodating the maintaining of the pulse widths according to the gray scales.

10. The method of claim 1, with the pulses of the even data signals are maintained from the end time points of the blanking periods until the pulse widths according to the gray scales.

11. The method of claim 1, with when the pulses of the odd data signals and the even data signals being applied continuously, including the blanking periods, to the data electrode lines while maintaining the pulse widths according to the respective gray scales, accommodating without a rising time necessary for the signal rising of the output pulse of the display data signal.

12. The method of claim 2, the pulses of the even data signals are maintained from the blanking periods to the pulse widths according to the gray scales.

13. The method of claim 12, wherein when the data signals have gray scales lower than a predetermined gray scale, pulses of the odd and even data signals maintain pulse widths according to respective gray scales and are continuous with blanking periods interposed therebetween, and when the data signals have gray scales higher than the predetermined gray scale, pulses of the odd data signals exceed an emission start voltage at the same time when data signals are applied, accommodating the pulse widths according to the gray scales being maintained, and are not continuous with pulses of even data signals in the blanking periods.

14. A method of driving an electron emission display device, the method comprising:
applying display data signals to data electrode lines comprising odd data signals and even data signals, which respectively correspond to an odd scan signal and an even scan signal; and
maintaining pulse widths of pulses of the odd and even data signals according to respective gray scales and are continuous with blanking periods interposed therebetween.

15. The method of claim 14, wherein the pulses of the odd data signals are delayed and maintained up to the blanking periods so as to maintain pulse widths according to the gray scales.

16. The method of claim 15, wherein the pulses of the even data signals are maintained from the blanking periods to the pulse widths according to the gray scales.

17. The method of claim 16, wherein when the data signals have gray scales lower than a predetermined gray scale, pulses of the odd and even data signals maintain pulse widths according to respective gray scales and are continuous with blanking periods interposed therebetween, and when the data signals have gray scales higher than the predetermined gray scale, pulses of the odd data signals exceed an emission start voltage at the same time when data signals are applied, accommodating the pulse widths according to the gray scales being maintained, and are not continuous with pulses of even data signals in the blanking periods.

18. A computer-readable medium having computer-executable instructions for performing a method, comprising:
applying the display data signals to data electrode lines comprising odd data signals and even data signals, which respectively correspond to an odd scan signal and an even scan signal, with the applied display data signals having pulse widths according to gray scales to data electrode lines while scan signals are applied to scan electrode lines of said electron emission display panel; and
generating pulse widths of pulses of the odd and even data signals according to respective gray scales and are continuous with blanking periods interposed therebetween.

19. The computer-readable medium having computer-executable instructions for performing the method of claim 18, wherein the pulses of the odd data signals are delayed and maintained up to the blanking periods accommodating to maintain pulse widths according to the gray scales and the pulses of the even data signals are maintained from the blanking periods to the pulse widths according to the gray scales.

20. The computer-readable medium having computer-executable instructions for performing the method of claim 19, wherein when the data signals have gray scales lower than a predetermined gray scale, pulses of the odd and even data signals maintain pulse widths according to respective gray scales and are continuous with blanking periods interposed therebetween.
